(19) United States
(12) Patent Application Publication
(10) Pub. No.: US 2009/0120853 A1
(43) Pub. Date: May 14, 2009

(54) ENDLESS STREAM FISH TANK

(75) Inventor: Thomas Joseph Vento, New Port Richey, FL (US)

Correspondence Address: AKERMAN SENTERFITT, P.O. BOX 3188, WEST PALM BEACH, FL, 33402-3188, US

(73) Assignee: KEEPALIVE, INC., New Port Richey, FL (US)

(21) Appl. No.: 11/937,961

(22) Filed: Nov. 9, 2007

(51) Int. Cl. A01K 63/04

(52) U.S. Cl. 210/130; 210/137; 210/167.21; 210/167.26; 210/167.27

(57) ABSTRACT

A single tank configuration of a fish tank or livewell includes an outer container; an inner container installed inside the outer container, the inner container having a first end with an entry hole and a second end with an exit hole; and a pump installed between the inner and outer containers at one end of the fish tank or livewell for facilitating water circulation inside the fish tank or livewell. The inner and outer containers have an elongated shape. A double tank configuration of a fish tank or livewell includes two single tanks; connecting pipes for connecting the two single tanks to each other; and at least one pump installed between the two single tanks (130), the at least one pump being connected to the connecting pipes (150) for facilitating water circulation in the two single tanks. In each of the tank configurations, an endless water stream is formed in one straight direction within the tank and the water speeds can be adjusted by the pump(s). All variations of the endless stream tanks, including portable single tanks, portable double tanks, and permanently installed boat livewells can utilize a raw water entry at the inlet of the tank with an overboard discharge at the outlet to provide a unidirectional flow within the tank, and thereby maintaining the endless stream concept. This can be utilized as a back-up system in the event of aeration pump failure, or to provide changing of the tank water.

### FIELD OF THE INVENTION

The present invention relates in general to a fish tank, either portable or installed in a boat as a livewell, for keeping fish or bait alive in a healthy condition and, more specifically, to a portable fish tank or a livewell that provides an artificial current in the water for species of fish that require continuous movement to keep them in a healthier and less stressed environment.

### BACKGROUND OF THE INVENTION

In order to maintain species of fish that require continuous movement through the water, an artificial current must be provided in portable tanks or livewells to ensure their survival. Fast swimming fish will school in the current along the perimeter of the tank. The size of the fish that can be maintained is limited by the diameter of the tank. Larger fish would need an extremely large tank to ensure that they can swim without their bodies being continuously curved and causing them damage. These types of tanks are not only stressful for the fish, but cumbersome, and take up valuable deck space for passengers, increase the weight of the boat, and may also cause safety hazards.

Japanese Patent Application JP 59-167396 A discloses a live-fish tank 2 in a fishing boat in which a water jet pipe 3 is provided in a position slightly higher than the bottom face of the live-fish tank having a hatch 4 at the center of its ceiling. A number of jet holes, which jet out water deflected from the center of the tank 2 are provided on the jet pipe. By jetting out sea water, a whirling stream A is generated in the upper part of the tank 2 for live fish to swim in (see FIG. 1). Similar to the conventional oval or round tanks, the fish tank disclosed by JP 59-167396 A must also be large in order to maintain live fish.

### SUMMARY OF THE INVENTION

The object of the invention is therefore to overcome the above-mentioned drawbacks of the prior art live-fish tanks and to provide a fish tank, either portable or installed in a boat as a livewell, that (a) will provide an environment to allow small or large fish to swim in a more natural state, and (b) is smaller and lighter than the conventional bait and fish tanks, and thus save deck space and reduce the weight added to the boat.

The above object is achieved by producing continuous water movement in one direction in a long and narrow rectangular tank. The tank includes an inner container for fish to swim in and an outer container for facilitating water circulation. The water enters the inner container at one end through an entry hole and exits the inner container into the outer container at the other end of the inner container through an exit hole, and then returns to the entry hole back into the inner container. This creates an endless stream in the inner container. During the circulation of the water, it can also provide aeration required for fish within the inner container. This tank simulates a more natural movement of water for fish survival. The fish will swim upstream and in one direction. Water speeds may be adjusted according to the swimming speeds of the species of fish contained in the inner container by a pump installed in the outer container.

The endless stream fish tank or livewell according to the invention has the advantage that it requires less space than the conventional large round, oval or square tanks or livewells. It is long and narrow and can be placed alongside the gunwales of a boat allowing more passenger space.

The inner container of fish tank is designed to ensure a continuous stream of water with minimal eddies of water. The bottom of the inner container and/or the outer container of the tank can have a semi-circular shape to further reduce the size and weight of the tank by reducing the amount of water needed. The side walls of the outer container can be formed in corrugated shape to increase tank stability and reduce weight.

The fish tank or livewell according to the concept of the present invention can also be designed as a double tank configuration with each tank having a similar structure to the inner container of the single tank configuration as described above. The pump(s) may be installed between the two single tanks. In one embodiment, aeration can occur by metering gasses between two pumps. Air or pure oxygen can be inserted by either venturi or pressure. The downstream pump will allow continuous pressure to the upstream pump. This will allow maximum gasses to mix with the upstream pump without any deterioration of pump pressure in the line. This is required for fish that require continuous fast movement through the water.

If a slower moving fish needs to be maintained within the tank, the downstream pump can be bypassed. Metering of gases will occur between the pumps, or downstream of the upstream pump. Metering of gases downstream of the upstream pump will allow the speed of the upstream pump to be variable while maintaining water aeration. Water speed can be slowed almost to the point where the pump will start to cavitate in order to accommodate slower swimming species.

Both the single tank and double tank designs of the invention can be utilized as a portable fish tank or in permanent boat installations. The livewell can be a simple design, and plumbing can be hidden under the boat decking.

The single tank configuration allows all water flows required to be within the tank, and thus reduces plumbing requirements and hazards.

### BRIEF DESCRIPTION OF THE DRAWINGS

There are shown in the drawings, embodiments which are presently preferred. It is expressly noted, however, that the invention is not limited to the precise arrangements and instrumentalities shown.

FIG. 1 shows a prior art live-fish tank disclosed by JP 59-167396 A.

FIG. 2 is a perspective view of an embodiment of a single tank configuration according to the present invention.

FIG. 3 is a horizontal cross-sectional view of the single tank configuration as shown in FIG. 2.

FIG. 4 is a diagram showing the water flow direction in the single tank configuration as shown in FIGS. 2-3.

FIG. 5 is a side cross-sectional view of the single tank configuration as shown in FIG. 2.

FIG. 6 diagrammatically shows an embodiment of a double tank configuration according to the present invention.

FIG. 7 is a side view of one side of an embodiment of the double tank configuration according to the present invention.

FIG. 8 is a side view of the other side of the embodiment of the double tank configuration as shown in FIG. 7.

FIG. 9 is a top perspective view showing the side of the double tank configuration as shown in FIG. 7.

FIG. 10 is a top perspective view showing the side of the double tank configuration as shown in FIG. 8.

FIG. 11 is a bottom perspective view of the double tank configuration.

### DETAILED DESCRIPTION OF THE INVENTION

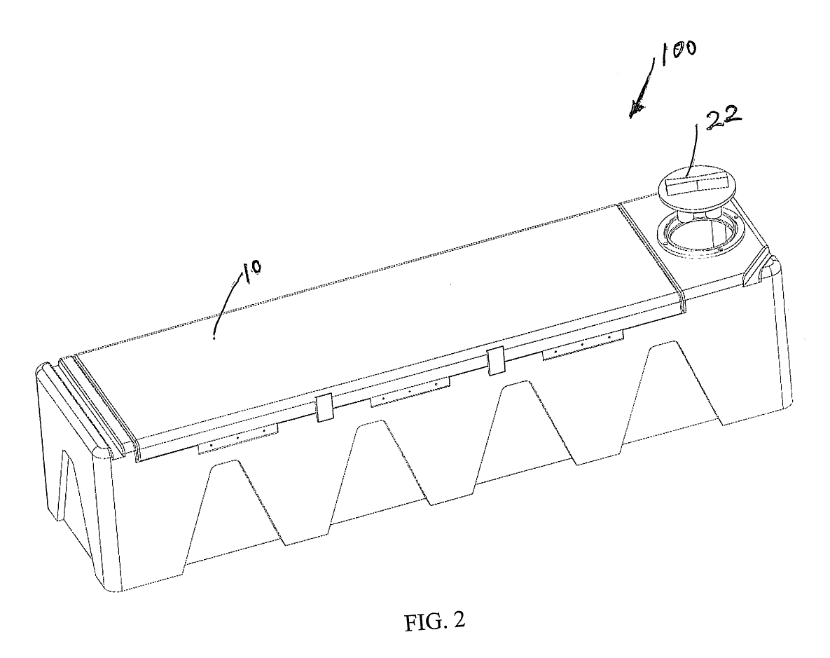

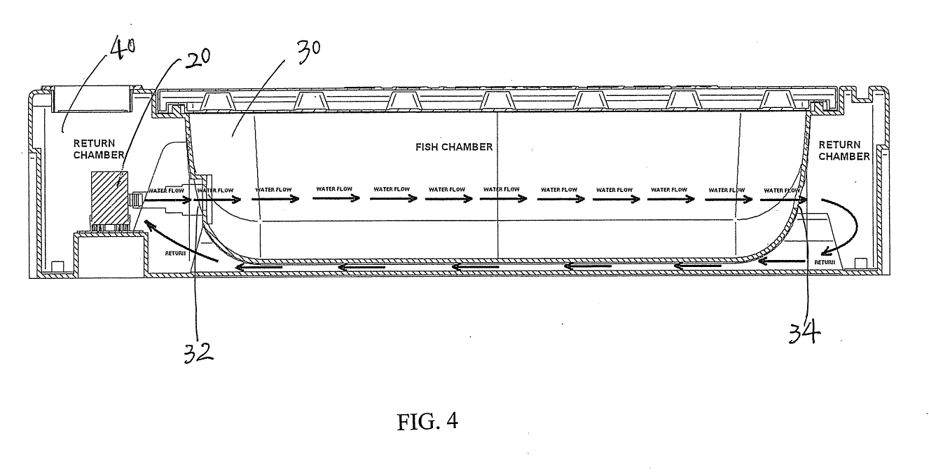

FIGS. 2-5 show an embodiment of a single tank configuration of the present invention. FIG. 2 is a perspective view of the single tank configuration. As can be seen in FIG. 2, the single tank 100 has an elongated narrow and square shape and has a tank lid 10 which can be opened up when putting fish in the tank or getting fish out of the tank. The tank lid 10 is closed during normal operating conditions. The tank lid 10 can be connected to one side of the outer container 40 by hinges or any other connecting mechanism. A pump lid 22 for a pump 20 (see FIG. 4) installed inside the tank is shown at one end of the tank. The pump lid 22 can be lifted when adding water into the tank or servicing the pump 20.

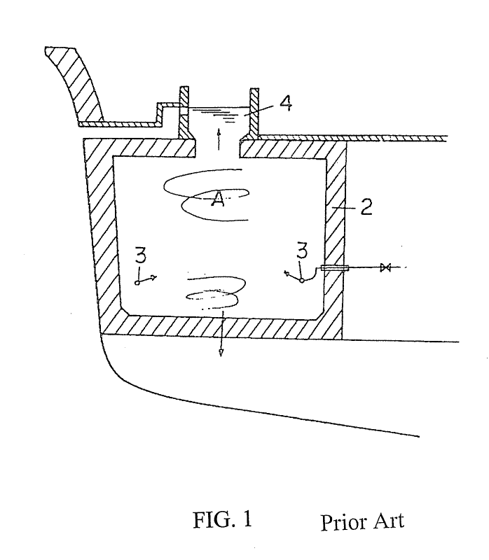

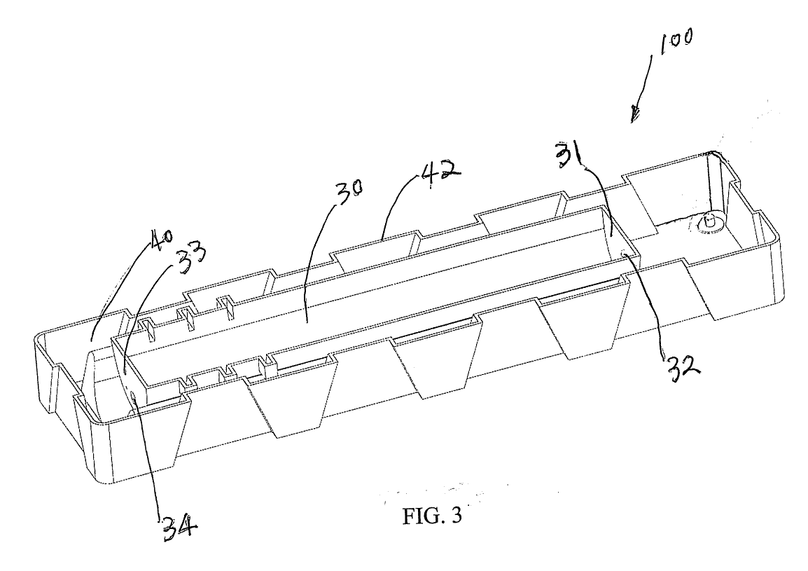

FIG. 3 is a horizontal cross-sectional view of the single tank configuration as shown in FIG. 1. As can be seen in FIG. 3, the tank 100 includes an inner container 30 and an outer container 40, which have similar shapes. The inner container functions as a fish chamber. The space between the inner and outer containers 30, 40 functions as a return chamber and should be limited to a minimum extent, just enough for water circulation. This can reduce the amount of water needed for the tank and thus reduce the overall operating weight of the fish tank. A pump 20 (not shown in FIG. 3, but shown in FIG. 4) is installed inside the outer tank 40 at one end thereof but outside of the inner tank 30. The pump 20 can be used to adjust the speed of the water stream in the tank and also provide aeration. The pump 20 may also be connected to an exterior gas or oxygen tank. The outer wall 42 of the outer container 40 can be formed with corrugated shapes, such as “M” shapes, in order to increase the stability and reduce the weight of the tank.

The inner container 30 has a first end 31 and a second end 33. An entry hole 32 is formed in the first end 31 and an exit hole 34 is formed in the second end 33. The water enters the inner container 30 at the first end 31 through the entry hole 32 and exits the inner container 30 into the outer container 40 at the second end 33 of the inner container 30 through the exit hole 34. After passing through the space between the inner and outer containers 30, 40, the water then returns to the entry hole 32 and back into the inner container 30. This creates an endless stream in a straight direction in the inner container 30 for fish to swim against. The water circulation direction is shown in the diagram of FIG. 4. This simulates a more natural movement of water for fish survival. The fish will swim upstream and in one straight direction. Water speeds may be adjusted according to the swimming speeds of the species of fish contained in the inner container by the pump 20 installed in the outer container 40.

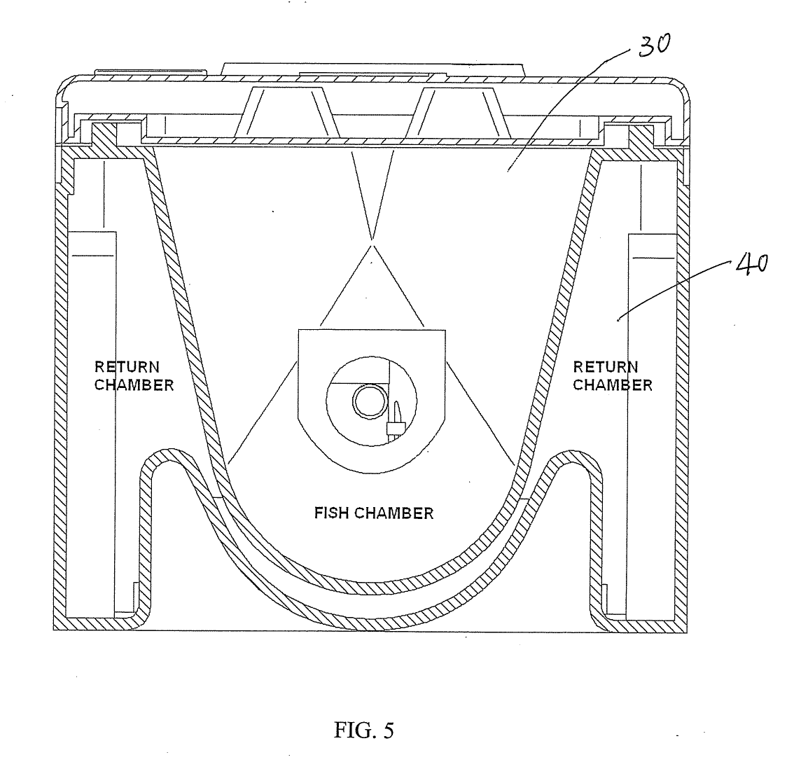

The inner container 30 of the fish tank 100 is designed to ensure a continuous stream of water with minimal eddies of water. The bottom of the inner container and/or the outer container of the tank can have a semi-circular shape to further reduce the size and weight of the tank by reducing the amount of water needed (see FIG. 5). The bottom of the outer container can be formed with semi-circular shape especially when the fish tank is to be installed as a livewell in a boat.

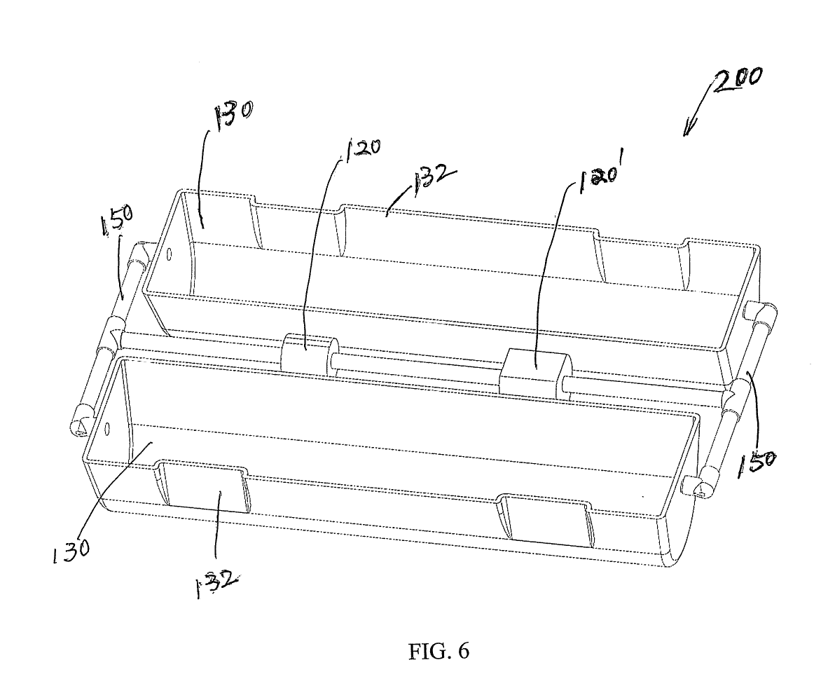

FIG. 6 shows a double tank configuration 200 according to the present invention. Each tank 130 has a similar structure as the inner container 30 of the single tank configuration as described above except that the two single tanks 130 can have a side wall 132 formed with corrugated shapes like the outer container 40 of the single tank configuration 100. The two tanks 130 are connected by connecting pipes 150. The pump(s) may be installed between the two single tanks 130 and connected to the connecting pipes 150 to facilitate water circulation in both tanks. FIG. 6 shows two pumps, an upstream pump 120 and a downstream pump 120′. In one embodiment, aeration can occur by metering gasses between the two pumps. Air or pure oxygen can be inserted by either venturi or pressure. The downstream pump 120′ will allow continuous pressure to the upstream pump 120. This will allow maximum gasses to mix with the upstream pump 120 without any deterioration of pump pressure in the line. This is required for fish that require continuous fast movement through the water.

If slower moving fish needs to be maintained within the tank, the downstream pump 120′ can be bypassed. Metering of gases will occur between the pumps, or downstream of the upstream pump. Metering of gases downstream of the upstream pump will allow the speed of the upstream pump to be variable while maintaining water aeration. Water speed can be slowed almost to the point where the pump will start to cavitate in order to accommodate slower swimming species.

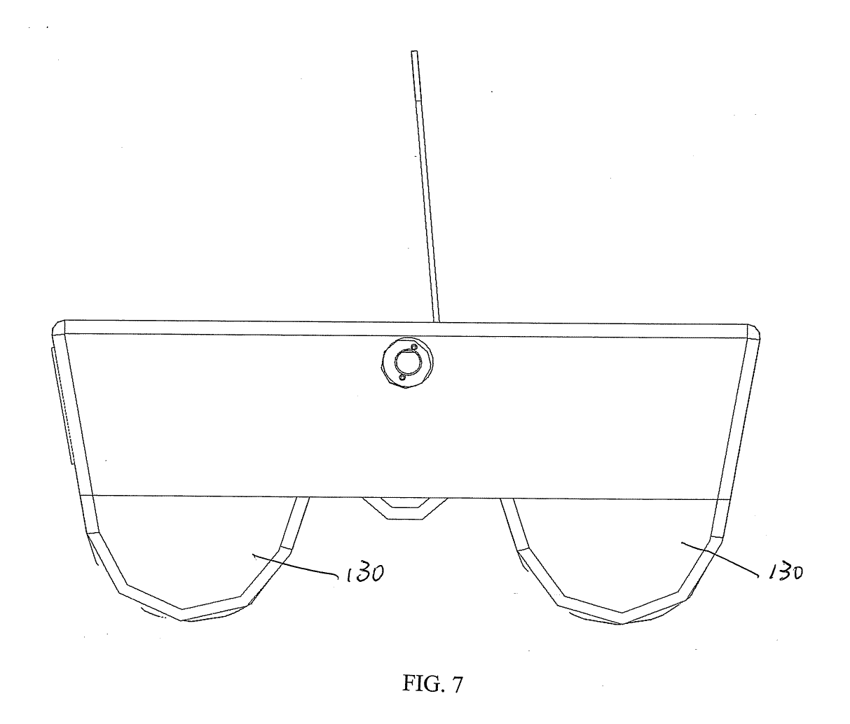

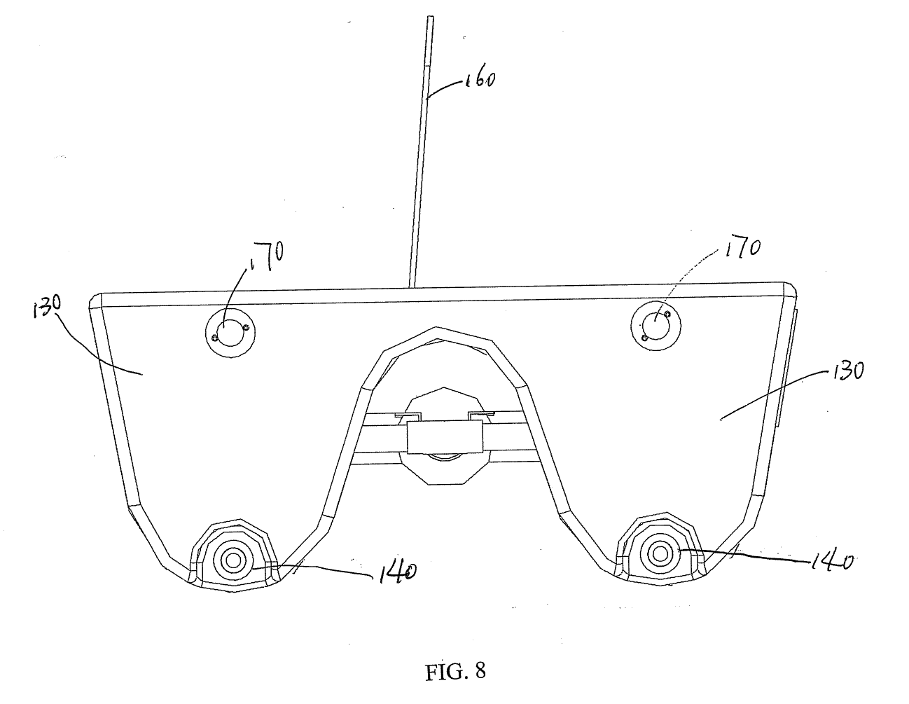

FIGS. 7-8 are side views showing each side of an embodiment of the double tank configuration. Similar to the single tank configuration, the bottom of the tanks 130 of the double tank configuration can also have a semi-circular shape to reduce the size and weight of the tank. As shown in FIG. 8, a drain 140 may be provided at the bottom of the tanks 130 for discharging the water in the tank.

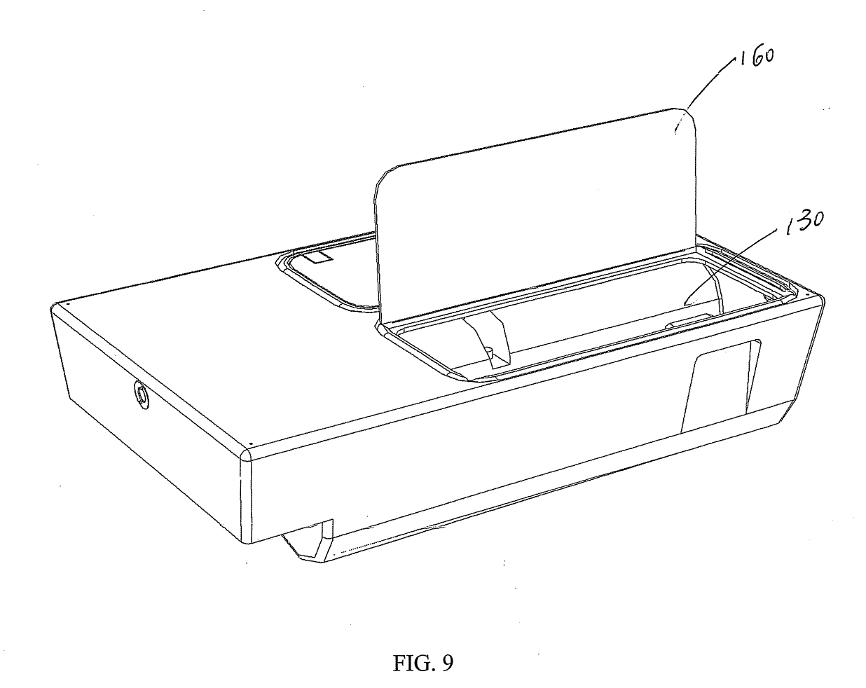

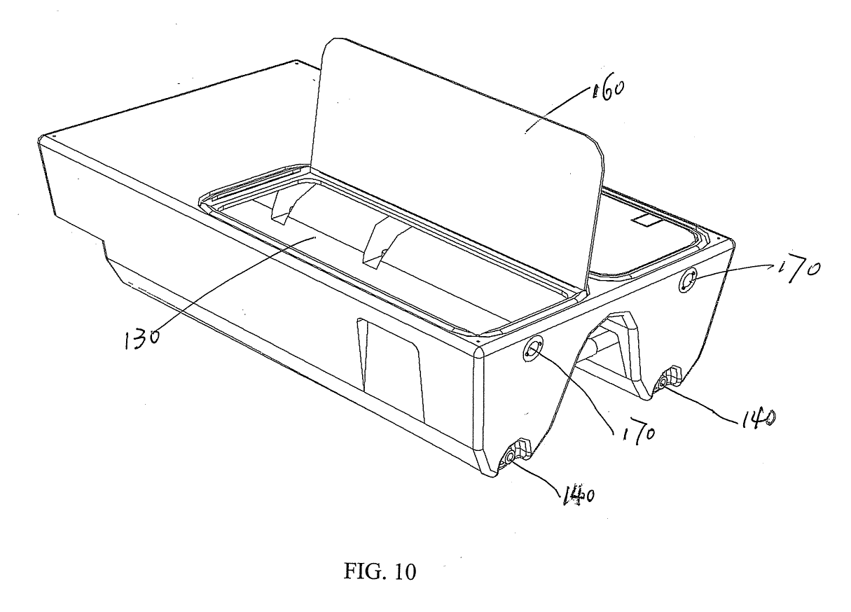

FIGS. 9-10 are top perspective views showing the two sides of the double tank configuration as shown in FIGS. 7-8. As can be seen in FIGS. 9-10, a lid 160 is provided for each tank 130.

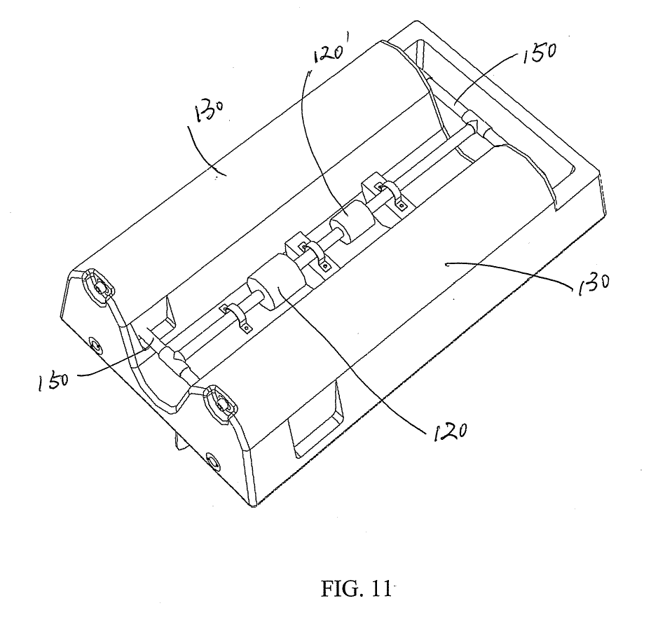

FIG. 11 is a bottom perspective view of the double tank configuration as shown in FIGS. 7-10, showing the connecting pipes 150 and pumps 120, 120′.

All variations of the endless stream tanks, including portable single tanks, portable double tanks, and permanently installed boat livewells can utilize a raw water entry at the inlet of the tank with an overboard discharge 170 (see FIGS. 8 and 10) at the outlet to provide a uni-directional flow within the tank, and thereby maintaining the endless stream concept. This can be utilized as a back-up system in the event of aeration pump failure, or to provide changing of the tank water.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

I claim:

1. A single tank configuration (100) of a fish tank or livewell, comprising:
an outer container (40);
an inner container (30) installed inside the outer container (40), the inner container having a first end (31) with an entry hole (32) and a second end (33) with an exit hole (34); and
a pump (20) installed between the inner and outer containers (30, 40) at one end of the fish tank or livewell for facilitating water circulation inside the fish tank or livewell;
wherein the inner and outer containers (30, 40) have an elongated shape.

2. The single tank configuration of claim 1, wherein, under a pressure generated by the pump, the water enters the inner container (30) at the first end (31) through the entry hole (32) and exits the inner container (30) into the outer container 40 at the second end (33) of the inner container (30) through the exit hole (34), and then returns to the entry hole (32) back into the inner container (30) after passing through a space between the inner and outer containers (30, 40), thus forming an endless water stream in a straight direction inside the inner container (30).

3. The single tank configuration of claim 1, further comprising a tank lid (10) for closing the fish tank or livewell during normal operating condition.

4. The single tank configuration of claim 3, wherein the tank lid (10) is connected to one side of the outer container by hinges or any other suitable connecting mechanism.

5. The single tank configuration of claim 1, further comprising a pump lid (22) for closing the pump (20) during normal operating condition.

6. The single tank configuration of claim 1, wherein the outer container (40) has a wall (42) formed with corrugated shapes.

7. The single tank configuration of claim 1, wherein water speeds are adjusted according to swimming speeds of species of fish contained in the inner container (30) by the pump (20).

8. The single tank configuration of claim 1, wherein a bottom of the inner container (30) is formed as a semi-circular shape.

9. The single tank configuration of claim 7, wherein a bottom of the outer container (30) is formed as a semi-circular shape.

10. The single tank configuration of claim 2, wherein the space between the inner and outer containers (30, 40) is limited to a minimum extent, just enough for water circulation.

11. The single tank configuration of claim 1, wherein the pump provides aeration in the inner container (30).

12. A double tank configuration (200) of a fish tank or livewell, comprising:
two single tanks (130);
connecting pipes (150) for connecting the two single tanks to each other; and
at least one pump (120, 120′) installed between the two single tanks (130), the at least one pump (120, 120′) being connected to the connecting pipes (150) for facilitating water circulation in the two single tanks.

13. The double tank configuration of claim 11, wherein the two single tanks (130) have a side wall (132) formed with corrugated shapes.

14. The double tank configuration of claim 11, wherein water speeds in the two single tanks are adjusted according to swimming speeds of species of fish contained therein by the at least one pump (120, 120′).

15. The double tank configuration of claim 11, wherein the at least one pump includes an upstream pump (120) and a downstream pimp (120′), aeration occurs by metering gasses between the two pumps.

16. The double tank configuration of claim 15, wherein the downstream pump (120′) can be bypassed.
